(19) United States
(12) Patent Application Publication
(10) Pub. No.: US 2008/0164228 A1
(43) Pub. Date: Jul. 10, 2008

(54) GARMENT HANGER CONTAINER

(76) Inventor: Brenda G. Powell, Princeton, WV (US)

Correspondence Address: Brenda G. Powell, 126 Cardinal Pine Drive, Lexington, SC, 29073, US

(21) Appl. No.: 11/621,761

(22) Filed: Jan. 10, 2007

(51) Int. Cl. A47F 7/28; B23P 17/04

(52) U.S. Cl. 211/49.1; 29/592

(57) ABSTRACT

A container for storing garment hangers includes a rigid body portion including a closed end portion and three side walls intersecting the closed end portion and extending therefrom to form an open end portion opposite the closed end portion, the open end portion being generally parallel to the closed end portion, and a vertical slot defined by two of the three side walls and extending from the open end portion to the closed end portion, the vertical slot being configured to receive a neck portion of the garment hangers. A method of manufacturing a container for storing garment hangers includes forming a body portion including a closed end portion and three side walls intersecting the closed end portion and extending therefrom to form an open end portion opposite the closed end portion and generally parallel thereto, and forming a vertical slot between two of the three side walls that extends from the open end portion to the closed end portion.

### TECHNICAL FIELD

This invention relates to a container for storing garment hangers.

### BACKGROUND

It is often desirable to store garment hangers in a container that prevents entanglement of the hangers when not in use, but provides ready access to a single hanger or group of hangers when needed.

### SUMMARY

In one general aspect, a container for storing garment hangers includes a rigid body portion including a closed end portion and three side walls intersecting the closed end portion and extending therefrom to form an open end portion opposite the closed end portion. The open end portion is generally parallel to the closed end portion. The container also includes a vertical slot defined by two of the three side walls and extending from the open end portion to the closed end portion, the vertical slot being configured to receive a neck portion of the garment hangers.

Implementations can include one or more of the following features. For example, the body portion has a substantially triangular configuration. In addition, the container can further include a guide, which can also be triangular, formed in a central portion of the body portion and extending between the closed end portion and the open end portion. The guide is configured to be received through a central portion of the garment hangers to maintain the garment hangers in a stacked and untangled state within the body portion. The guide includes three side walls intersecting the closed end portion and extending from the closed end portion to the open end portion of the body portion.

In another general aspect, a method of manufacturing a container for storing garment hangers includes forming a body portion including a closed end portion and three side walls intersecting the closed end portion and extending therefrom to form an open end portion opposite the closed end portion and generally parallel thereto, and forming a vertical slot between two of the three side walls that extends from the open end portion to the closed end portion.

Implementations can include one or more of the following features. The method of manufacturing includes forming a guide in a central portion of the body portion and extending between the closed end portion and the open end portion.

Advantages may include one or more of the following.

The container allows for placement, storage, and retrieval of garment hangers of varying size. The container also allows for garment hangers to be collected, stored and subsequently used in convenient locations, such as a home, store, laundry, or similar locations where garment hangers are removed from clothing.

The container also allows for single or multiple hangers to be placed into the container at one time, and likewise, provides from the removal of one or more hangers from the container at one time.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an isometric view of a container.

FIG. 2 is a front elevational view of the container of FIG. 1.

FIG. 3 is a top view of the container of FIG. 1.

### DETAILED DESCRIPTION

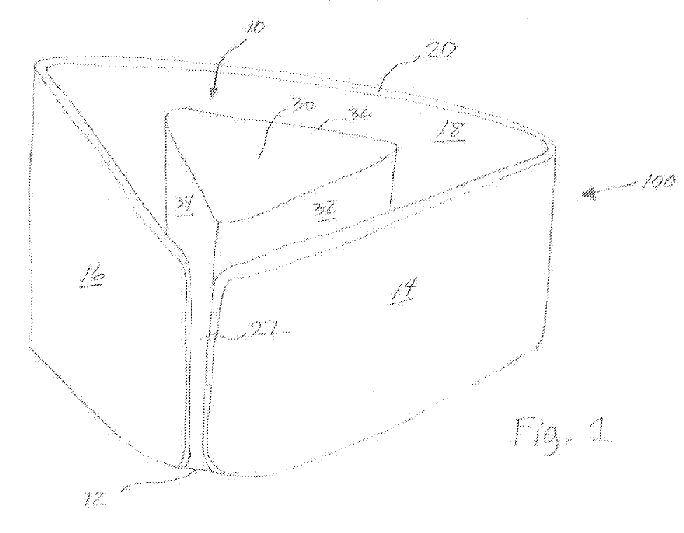

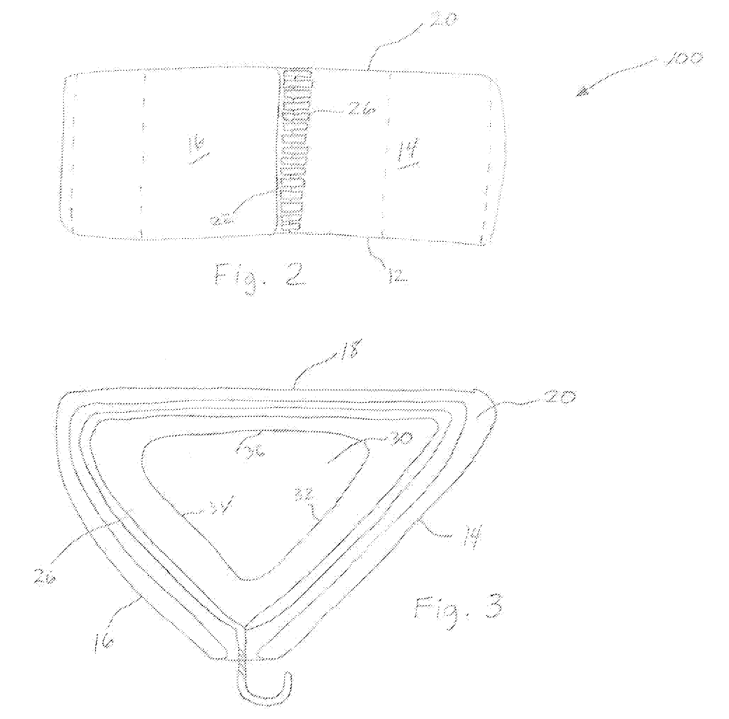

Referring to FIGS. 1, 2, and 3, a container for storing garment hangers 100 includes a body portion 10 of substantially of triangular configuration. Body portion 10 includes a closed end portion 12 and three side walls 14, 16, and 18 intersecting end portion 12 and extending from end portion 12. Side walls 14, 16, and 18 form an open end portion 20 opposite closed end portion 12. Open end portion 20 is generally parallel to closed end portion 12. The parallel configuration allows for multiple containers 100 to be stacked on top of each other in a well-known manner.

Side walls 14 and 16 define a vertical slot 22 that extends from open end portion 20 to closed end portion 12. Vertical slot 22 has a width sufficient to receive a neck portion of a garment hanger 26. Body portion 10 of garment hanger 100 is configured such that the neck portion of garment hangers 26 inserted into body portion 10 extend outside of vertical slot 22 while the remainder of garment hanger 26 is stored within body portion 10.

Body portion 10 further includes a substantially triangular guide 30 formed in the central portion of body portion 10. Guide 30 includes a three side walls 32, 34, and 36 intersecting closed end portion 12 and extending from closed end portion 12 to open end portion 20. Guide 30 is shaped and dimensioned to be received through a central portion of garment hangers 26 when hangers 26 are inserted into body portion 10 (see, e.g., FIG. 3). Guide 30 cooperates with side walls 14, 16, and 18 to maintain the garment hangers 26 in a stacked and untangled state within body portion 10 of container 100.

In operation, container 100 is placed on a shelf, floor, or other desired location, as for example, in a closet, laundry room, or other area. As a garment is removed from a garment hanger in a garment storage area, the garment hanger is inserted into the container 100. Alternatively, one can place multiple garment hangers into container 100 at one time. After being collected and stored in the container 100, the container 100 can be transported or carried to another location. Multiple containers 100 may be stacked on top of each other if additional storage capacity is required.

Container 100 is fabricated, for example, of any suitable material, including plastic, wood, metal, or the like. Container 100 is suitably molded in one piece using, for example, a common injection molding process.

A number of embodiments have been described. Nevertheless, it will be understood that various modifications may be made. For example, body portion 10, including closed end portion 12, sidewalls 14, 16, and 18, and guide 30, including sidewalls 32, 34, and 36, can be formed separately and then assembled together to form container 100. Further, a container 100 does not have to include guide 30 disposed in a central portion of body portion 10, and guide 30, if employed, may have any suitable geometric shape. In addition, although the container 100 depicted in FIGS. 1-3 and described above has particular use in a home, the container 100 can be any size and configuration for use in commercial laundries, dry cleaning establishments, department stores, and the like where garment hangers are stored in bulk or in large numbers.

Accordingly, other embodiments are within the scope of the following claims.

What is claimed is:

1. A container for storing garment hangers comprising:
a rigid body portion including a closed end portion and three side walls intersecting the closed end portion and extending therefrom to form an open end portion opposite the closed end portion, the open end portion being generally parallel to the closed end portion; and
a vertical slot defined by two of the three side walls and extending from the open end portion to the closed end portion, the vertical slot being configured to receive a neck portion of the garment hangers.

2. The container of claim 1, wherein the body portion has a substantially triangular configuration.

3. The container of claim 1, further comprising a guide formed in a central portion of the body portion and extending between the closed end portion and the open end portion.

4. The container of claim 3, wherein the guide is configured to be received through a central portion of the garment hangers to maintain the garment hangers in a stacked and untangled state within the body portion.

5. The container of claim 3, wherein the guide is substantially triangular.

6. The container of claim 3, wherein the guide includes three side walls intersecting the closed end portion and extending from the closed end portion to the open end portion of the body portion.

7. A method of manufacturing a container for storing garment hangers, comprising:
forming a body portion including a closed end portion and three side walls intersecting the closed end portion and extending therefrom to form an open end portion opposite the closed end portion and generally parallel thereto; and
forming a vertical slot between two of the three side walls that extends from the open end portion to the closed end portion.

8. The method of claim 7, further comprising forming a guide in a central portion of the body portion and extending between the closed end portion and the open end portion.
